(19) United States
(12) Patent Application Publication
(10) Pub. No.: US 2024/0092115 A1
(43) Pub. Date: Mar. 21, 2024

(54) PORTABLE CLIPBOARD SYSTEM AND METHOD OF USE

(71) Applicant: Daniel Graham, Oak Grove, MO (US)

(72) Inventor: Daniel Graham, Oak Grove, MO (US)

(21) Appl. No.: 18/369,398

(22) Filed: Sep. 18, 2023

Related U.S. Application Data
(60) Provisional application No. 63/407,291, filed on Sep. 16, 2022.

(51) Int. Cl. B42F 9/00

(52) U.S. Cl. CPC B42F 9/002

(57) ABSTRACT

A clipboard with fold-out, extendable legs. This allows the user to set the extended legs on the floor leaving the clipboard standing in a horizontal position at a convenient hip height. With this, the user has both hands free for the task and a practical, convenient place for the clipboard to rest. With the legs in the extended position, it is strong enough to write on and light enough to pick up and move to a new location

### CROSS-REFERENCE TO RELATED APPLICATION

This application claims priority in U.S. Provisional Patent Application No. 63/407,291 Filed Sep. 16, 2022, which is incorporated herein by reference.

### BACKGROUND OF THE INVENTION

### 1. Field of the Invention

The present invention relates generally to a clipboard system and method for use thereof, and more specifically to a portable clipboard system with storable telescoping legs.

### 2. Description of the Related Art

The clipboard has not changed in functionality much over time. Clipboards exist which include document storage within the body of the clipboard or to include additional features, but the core use of clipboards remains the same—to be hand held or placed on a surface when used. Sometimes it is necessary for the user to have both hands free, necessitating awkwardly carrying the clipboard under an arm or locating a suitable location for placement. In the construction industry and many other industries, often there will be no such suitable location for placement as counters, tables, and other raised surfaces may not yet be installed. What is needed is a solution to allow a clipboard to be placed in a raised and usable position wherever desired by the user.

Heretofore there has not been available a system or method for a clipboard system with the advantages and features of the present invention.

### BRIEF SUMMARY OF THE INVENTION

The present invention generally provides a clipboard with fold-out, extendable legs. This allows the user to set the extended legs on the floor leaving the clipboard standing in a horizontal position at a convenient hip height. With this, the user has both hands free for the task and a practical, convenient place for the clipboard to rest. With the legs in the extended position, it is strong enough to write on and light enough to pick up and move to a new location.

An example of a typical use for such a device is in the construction industry. Workers may be required to enter a structure under construction, just after the framing stage, to measure for later projects, such as the installation of kitchen cabinets. At that stage of the construction process it is essentially an empty building, and there is nowhere to set a clipboard. This leaves users with two options: either tuck it under one arm or lay it on the floor. Many measurements may take place with a lot of back-and-forth to the clipboard writing down information. Bending over to the floor with every measurement was very inconvenient along with the difficulty of taking measurements with it tucked under one arm.

The present invention alleviates these issues by providing a ready-made raised position for the clipboard that can be placed at any location in an unfinished building or any other space, and which does not significantly increase the bulkiness or convenience of existing clipboard features and functions.

### BRIEF DESCRIPTION OF THE DRAWINGS

The drawings constitute a part of this specification and include exemplary embodiments of the present invention illustrating various objects and features thereof.

FIG. 1 is a three-dimensional isometric view of a preferred embodiment of the present invention shown in a first, compact and stored orientation.

FIG. 2 is a three-dimensional isometric view thereof shown in a second, deployed orientation, wherein the leg elements are shown having broken lengths indicating lengths of any suitable length.

FIG. 3 is another three-dimensional isometric view thereof shown in the second, deployed orientation with exemplarily lengthened legs.

FIG. 4 is a bottom plan view thereof shown in a first, compact and stored orientation.

FIG. 5 is a bottom plan thereof shown in an orientation wherein each of the leg elements are rotated out to be extended to the second, deployed orientation.

FIG. 6 is a top plan view of the embodiment of FIG. 4.

FIG. 7 is a top side elevational view thereof.

FIG. 8 is a right-side elevational view thereof, the left side being a mirror image thereof.

FIG. 9 is a is a top side elevational view shown in a second, deployed orientation.

FIG. 10 is a right-side elevational view thereof, the left side being a mirror image thereof.

FIG. 11 is a three-dimensional isometric view of an alternative embodiment of the present invention including an openable top element and being shown in the first, compact and stored orientation.

FIG. 12 is a three-dimensional isometric view thereof, showing one method of moving a top element from a base element thereof.

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

### II. Preferred Embodiment Portable Clipboard System 2

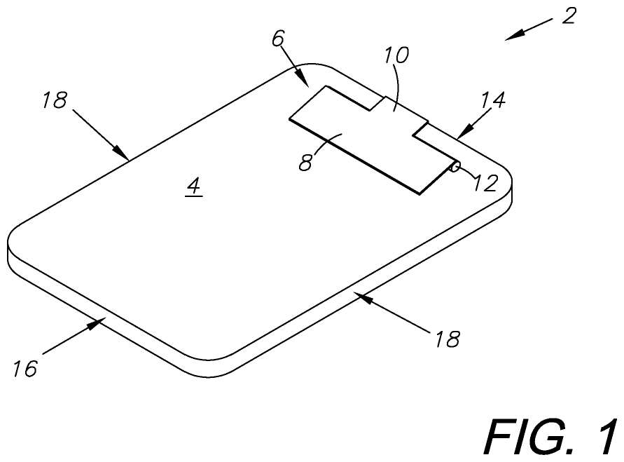

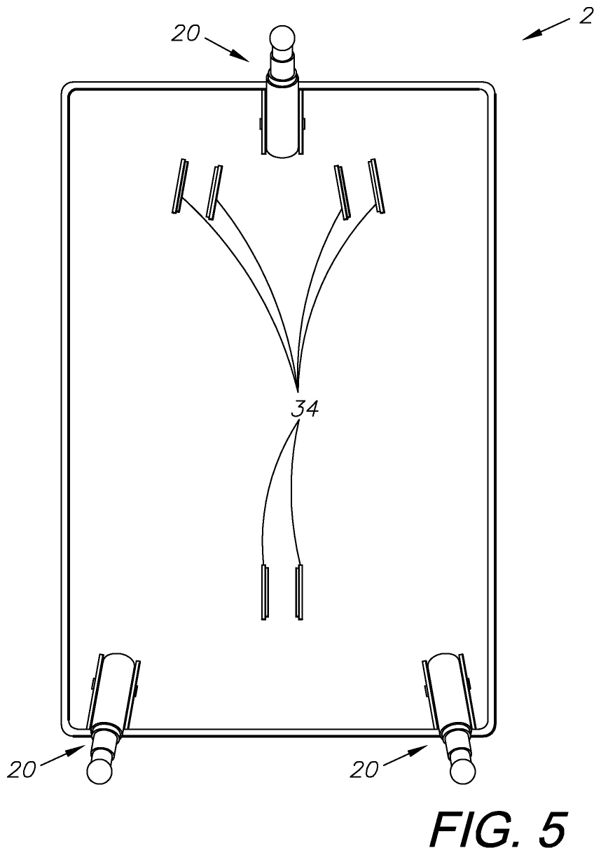

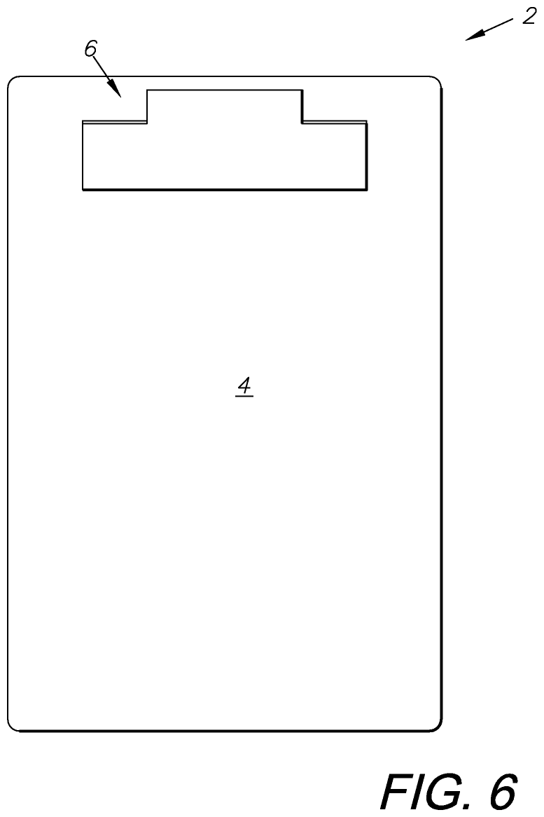

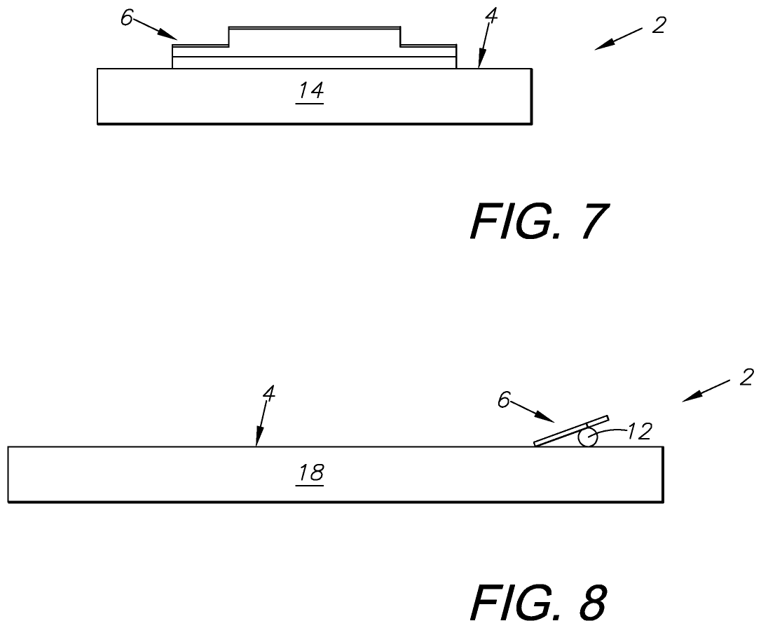

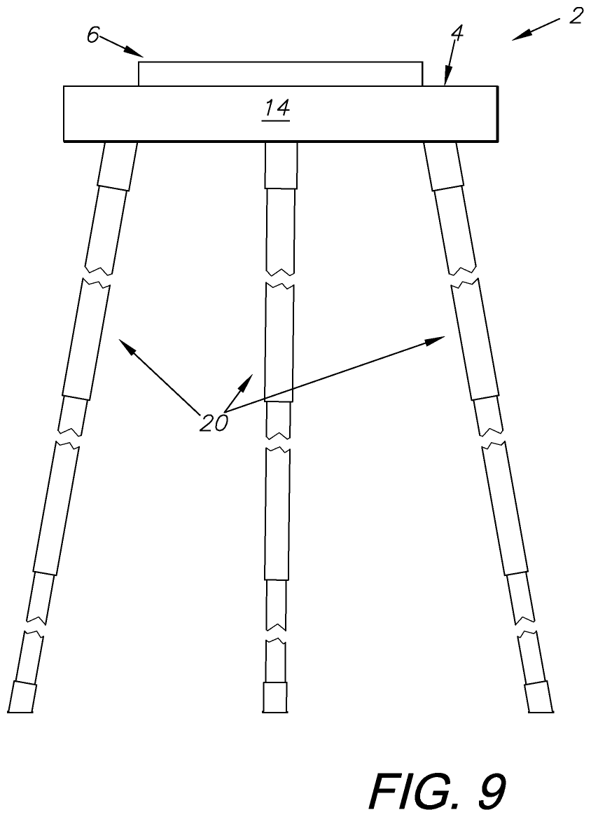

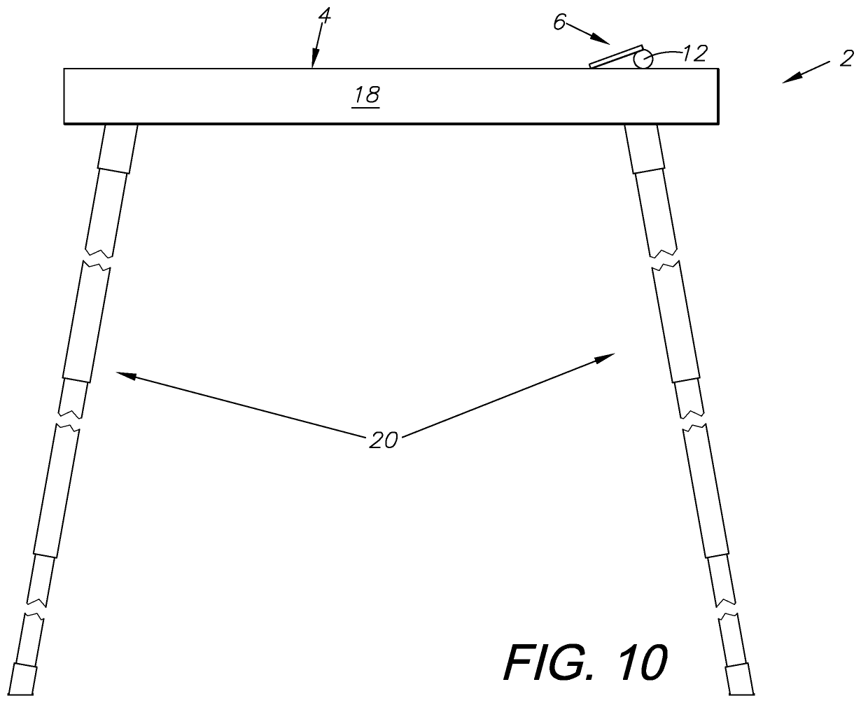

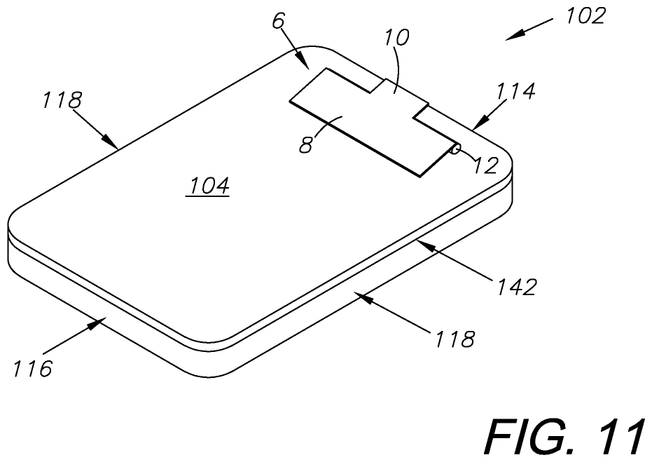

As shown in FIGS. 1-10, the present invention is a clipboard system 2 providing a clipboard base with a top face 4 for receiving documents and papers 40 which are secured by a clip element 6. The clip 6 includes the clip interface 8 with the clip handle 10, configured to be manually depressed to open the clip 6, and a hinge 12, spring, or other suitable element designed to provident tensional force downward on the clip 6 to best secure the documents and papers. A top end 14, bottom end 16, and sides 18 define the dimensions of the clipboard base.

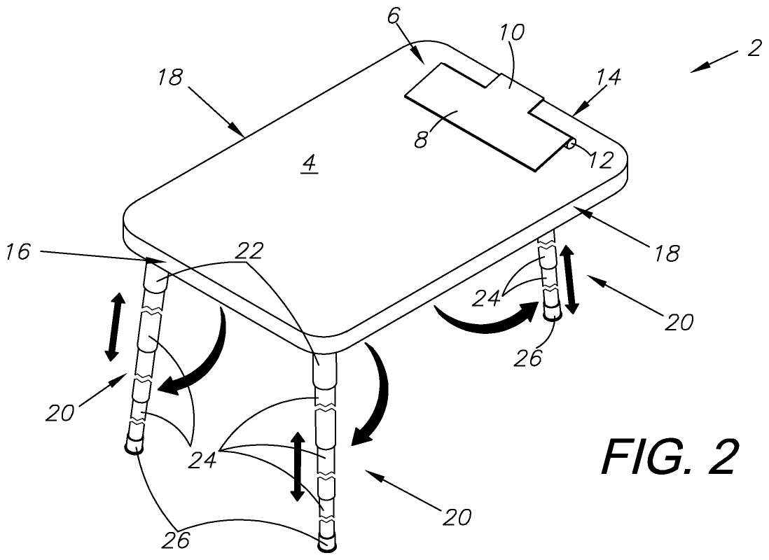

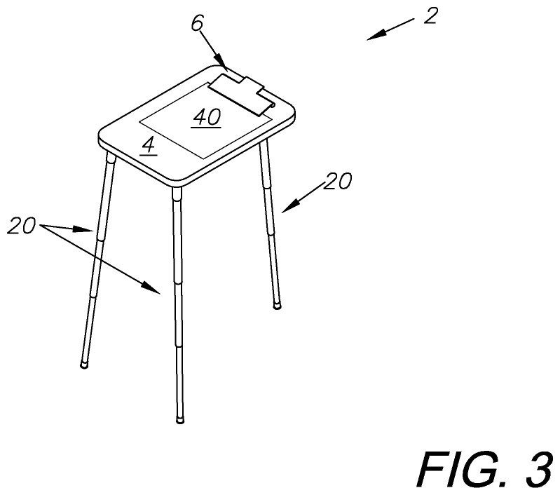

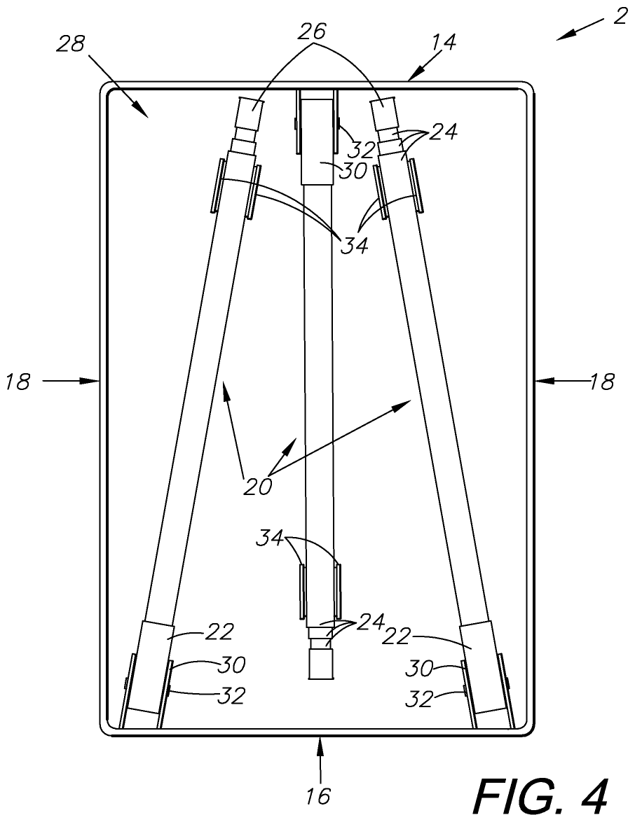

As shown in FIGS. 2 and 3, along with other figures, are three leg elements 20, each being made up of multiple telescoping segments 24 and ending in a foot 26. As shown further in FIG. 4, each leg element 20 has a pivotable base element 22 which connects to a pair of receivers 30 with a pin 32 about which the pivotable base element 22 can rotate. A pair of receivers 34 is designed to receive one of the telescoping segments 24 of the leg elements to secure them into place within the recessed storage space 28 formed beneath the top face 4 as defined by the top end 14, bottom end 16, and sides 18.

Each leg has a proximal end located adjacent to the recessed storage space 28, and a distal end terminating into a foot 26. The legs are each connected to a respective hinge or pivot point, such as the aforementioned pin 32, on the rear face at their respective proximal ends, while each distal end is capable of being telescoped away from the rear face located below the top face 4. The distal end of each leg may end in a foot 26 which may include a gripping material for placement against a floor or other ground surface.

As shown, the base has a rectangular shape. Two of the three legs 20 are connected to the base at the two corners formed by the top end 14 and the two sides 18. The third leg 20 is connected to at the center point of the bottom edge 16. This allows all three legs to easily collapse and fold up into their respective recesses within the base when in a stored, portable orientation. When in an extended, in-use orientation, each leg pivots out from their respective receiver and then can be telescoped to a desired height, such that the clipboard is positioned at a useable height above the ground surface.

### III. Alternative Embodiment Portable Clipboard System 102

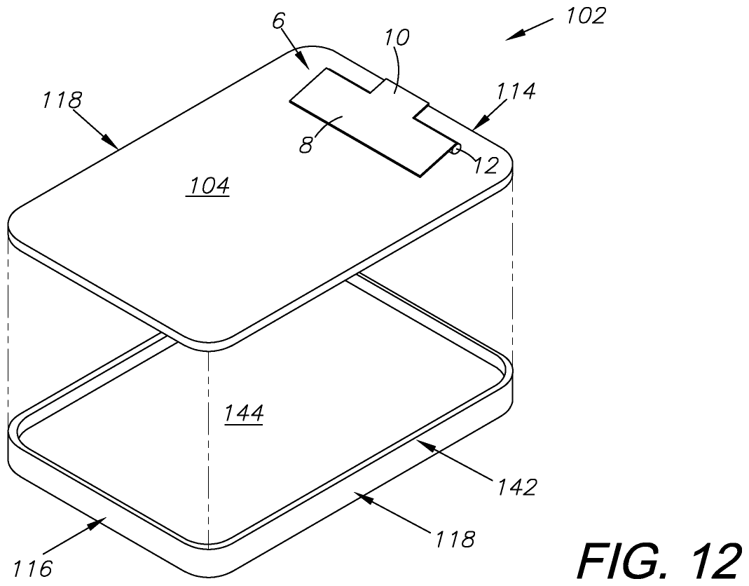

As shown in FIGS. 11-12, an alternative embodiment of the present invention has a similar clipboard system 102 providing a clipboard base with a top face 104 for receiving documents and papers which are secured by a clip element 6, identical to the previous embodiment. The same clip 6 includes the clip interface 8 with the clip handle 10, configured to be manually depressed to open the clip 6, and a hinge 12, spring, or other suitable element designed to provident tensional force downward on the clip 6 to best secure the documents and papers. A top end 114, bottom end 116, and sides 118 define the dimensions of the clipboard base.

In this embodiment, the clipboard system 102 may include a space 144 for receiving loose items or electronics, such as tablets and laptops. This space could have raised edges as shown, a textured surface for gripping, or other elements which can temporarily secure devices and items onto the to face surface. A separation 142 separates the top face from the bottom portion, and may be connected via a hinge, spring, or other suitable connector or may be selectively entirely removable.

It is to be understood that while certain embodiments and/or aspects of the invention have been shown and described, the invention is not limited thereto and encompasses various other embodiments and aspects.

1. A clipboard system comprising:
a base having a front face, a rear face, a top end, a bottom end, and a first side and a second side;
a clip connected to said front face of said base;
a first telescoping leg, a second telescoping leg, and a third telescoping leg, each pivotally connected to said rear face and each comprising a proximal end and a distal end;
said first telescoping leg proximal end connected to said rear face at a corner formed by said top end and said first side;
said second telescoping leg proximal end connected to said rear face at a corner formed by said top end and said second side;
said third telescoping leg proximal end connected to said rear face at a mid-point along said bottom end;
a first receiver, a second receiver, and a third receiver within said rear face each configured to receive and store the respective first telescoping leg, second telescoping leg, and third telescoping leg when the system is placed in a first, stored and portable orientation; and
each of said first telescoping leg, said second telescoping leg, and said third telescoping leg further configured to pivot out from their respective first, second, and third receivers, and to telescope to an extended position wherein the distal end of each respective first, second, and third telescoping legs are placed against a floor, thereby transforming said clipboard system into a second, deployed orientation whereby said front face is elevated away from said floor.
